(19) United States
(12) Patent Application Publication
(10) Pub. No.: US 2007/0002339 A1
(43) Pub. Date: Jan. 4, 2007

(54) Image processing apparatus and image processing method

(75) Inventors: Shunichi Megawa, Shizuoka-Ken (JP); Takahiro Fuchigami, Kanagawa-Ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/079,521

(22) Filed: Mar. 15, 2005

(51) Int. Cl. G06K 15/02

(52) U.S. Cl. 358/1.2; 358/1.13; 358/538

(57) ABSTRACT

An image processing apparatus includes an image inputting unit configured to input image data of an original image, an area specifying unit configured to specify a predetermined area in the input original image as a specified area, and a miniature image creating unit configured to create a miniature image of the original image such that a first image section of the specified area and a second image section of an area other than the specified area specified by the image inputting unit are reduced by different modes from each other. According to the present invention, a thumbnail appropriately indicating the content and the feature of an original image are readily and quickly created even if the original image includes a complex image section.

### BACKGROUND OF THE INVENTION

1. Field of the Invention

The present invention relates to an image processing apparatus and an image processing method. In particular, the present invention relates to an image processing apparatus and an image processing method capable of creating a thumbnail.

2. Description of the Related Art

Thumbnails (miniature images) are often used when desired image files are retrieved from hard disks contained in personal computers or from web pages.

Thumbnails are reduced-size reproductions of original images. Therefore, a user can view the content of an image file using a thumbnail of the image file more quickly than viewing the content by directly opening the original image file.

However, since thumbnails are produced by reducing original images, if an original image includes a complex image section, it is difficult for a user to determine whether the original image file is a desired file by viewing the content using only a thumbnail. As a result, the user must open the original image file to check the content, so that the operation is complicated and retrieving the desired file requires a long time.

Japanese Unexamined Patent Application Publication No. 2004-173085 discloses a technique for generating a margin in a thumbnail and writing a selected information item as an image section on the margin.

This technique realizes a thumbnail with much information, compared to a thumbnail produced by simply reducing an original image.

However, the amount of information attachable in the margin is limited. In addition, information appropriately indicating the content or the feature of the original image cannot be attached in many cases. As a result, it is difficult to determine whether an original image file is a desired file by viewing only a thumbnail with information attached in a margin.

Therefore, there is a demand for providing an image processing apparatus and an image processing method that is capable of readily and quickly creating a thumbnail appropriately indicating the content and the feature of an original image even if the original image includes a complex image section.

### SUMMARY OF THE INVENTION

Accordingly, it is an object of the present invention to provide an image processing apparatus and an image processing method that is capable of readily and quickly creating a thumbnail appropriately indicating the content and the feature of an original image even if the original image includes a complex image section.

In a first aspect of the present invention, an image processing apparatus includes an image inputting unit configured to input image data of an original image, an area specifying unit configured to specify a predetermined area in the input original image as a specified area, and a miniature image creating unit configured to create a miniature image of the original image such that a first image section of the specified area and a second image section of an area other than the specified area specified by the image inputting unit are reduced by different modes from each other.

In a second aspect of the present invention, an image processing method includes an image inputting step of inputting image data of an original image, an area specifying step of specifying a predetermined area in the input original image as a specified area, and a miniature image creating step of creating a miniature image of the original image such that a first image section of the specified area and a second image section of an area other than the specified area are reduced by different modes from each other.

### BRIEF DESCRIPTION OF THE DRAWINGS

FIG. 1 is a block diagram of an image processing apparatus according to a first embodiment of the present invention;

FIG. 2 shows an example of an area specifying unit of the image processing apparatus according to the first embodiment;

FIGS. 3A to 3C are illustrations for explanation of an example of a miniature image creating method in the image processing apparatus according to the first embodiment;

FIG. 4 is a block diagram of an image processing apparatus according to a second embodiment of the present invention;

FIGS. 5A and 5B are illustrations for explanation of an example of a layout creating method in the image processing apparatus according to the second embodiment;

FIG. 6 is a block diagram of a first example of a divided-region selecting unit of the image processing apparatus according to the second embodiment;

FIG. 7 is a block diagram of a second example of the divided-region selecting unit of the image processing apparatus according to the second embodiment;

FIG. 8 is a block diagram of a third example of the divided-region selecting unit of the image processing apparatus according to the second embodiment;

FIG. 9 is an illustration for explanation of a method for selecting a specified area and changing the selection of the specified area in the image processing apparatus according to the second embodiment;

FIGS. 10A and 10B are illustrations for explanation of an example of a miniature image creating method using a simple image section in the image processing apparatus according to the second embodiment;

FIG. 11 is a block diagram of an image processing apparatus according to a third embodiment;

FIG. 12 is a block diagram of an image processing apparatus according to a fourth embodiment;

FIGS. 13A and 13B are illustrations for explanation of a miniature image creating method using only a layout in the image processing apparatus according to the fourth embodiment.

### DESCRIPTION OF THE PREFERRED EMBODIMENTS

The image processing apparatus and the image processing method according to the embodiments are described below with reference to the drawings.

### (1) First Embodiment

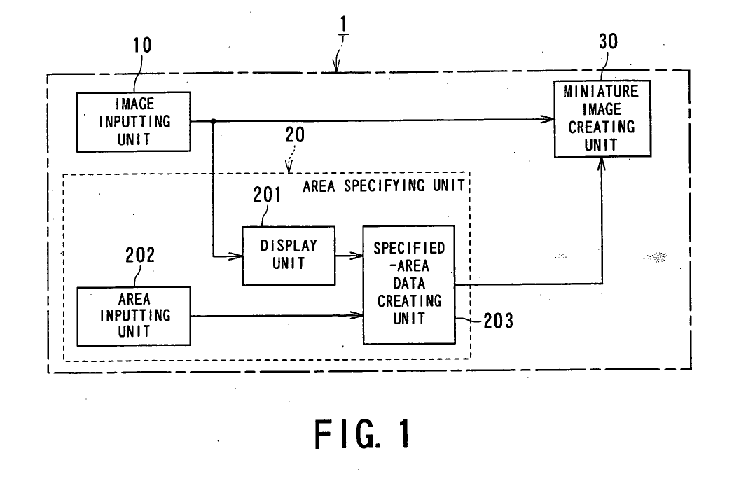

FIG. 1 shows an image processing apparatus 1 according to a first embodiment of the present invention.

The image processing apparatus 1 includes an image inputting unit 10 for inputting image data of an original image, an area specifying unit 20 for specifying a predetermined area in the input original image as a specified area, and a miniature image creating unit 30 for creating an miniature image (thumbnail) of the original image such that a first image section of the specified area and a second image section of an area other than the specified area are reduced by different modes from each other.

The area specifying unit 20 includes a display unit 201 for displaying an original image, an area inputting unit 202 for inputting a specified area by a user, and a specified-area data creating unit 203 for creating specified-area data from the input specified area.

The image inputting unit 10 may have various forms. For example, the image inputting unit 10 may be a form capable of receiving image data from an image data generating device, such as a scanner, a digital camera, or the like.

Alternatively, the image inputting unit 10 may be a form capable of receiving image data from an external storage medium, such as a compact disk read-only memory (CD-ROM), a digital versatile disk (DVD), or the like, or from a storage device, such as a hard disk contained in the image processing apparatus 1, or the like.

Alternatively, the image inputting unit 10 may be a communication interface of, for example, a local area network (LAN), the Internet, a telephone network, a leased line network, or the like. In this case, the network may be a wired one, a wireless one, or both.

The area specifying unit 20 sets a predetermined area as a specified area from input image data (original image) and creates data indicating the specified area. Setting a specified area may be performed by various techniques, such as a manual one, a semiautomatic one, an automatic one, or the like. In the image processing apparatus 1 according to the first embodiment, a specified area is set mainly by a manual technique.

In the first embodiment, the area specifying unit 20 has the structure including the display unit 201 and the area inputting unit 202. The area specifying unit 20 having such a structure may have various forms. For example, if the image processing apparatus 1 is a scanner or a multi-function peripheral (MFP), which handles multiple functions, for example, copying and printing, a control panel of the scanner or the MFP can function as the area specifying unit 20.

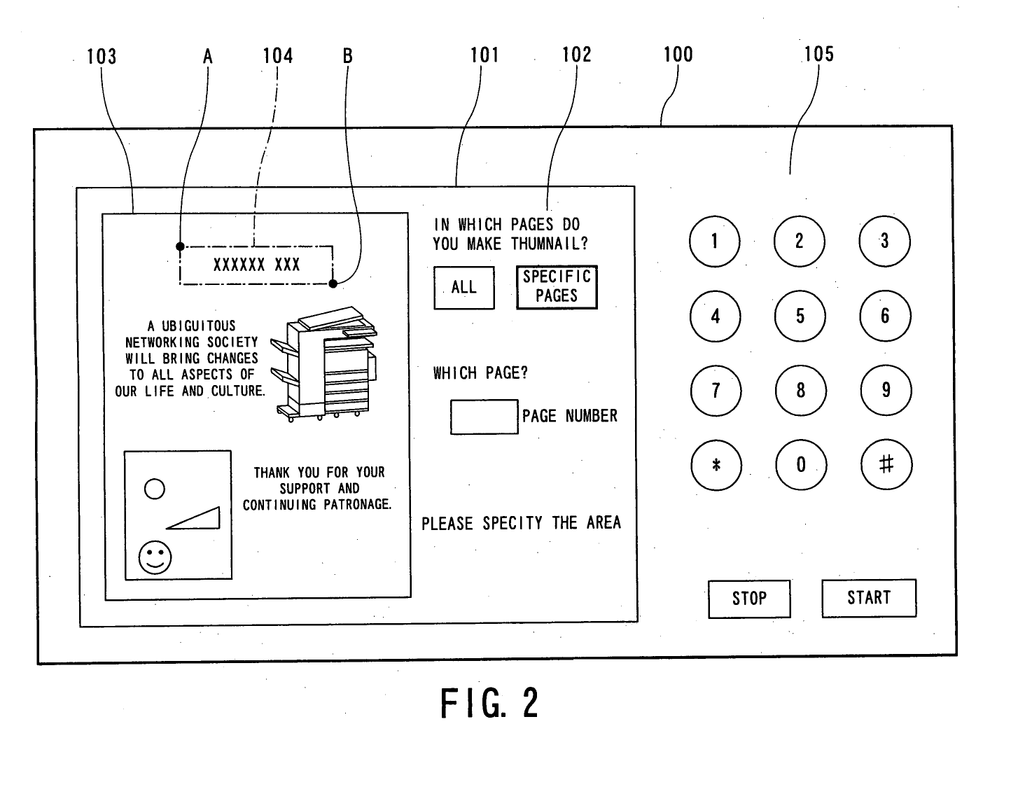

FIG. 2 shows an example of such a control panel of the MFP or the scanner. Operating keys 105 and a liquid crystal display (LCD) 101 serving as the display unit 201 are arranged on a control panel 100. The LCD 101 includes a touch panel 102 appearing thereon. A user can input various data and performs various settings using the touch panel 102.

When a user presses points A and B shown in FIG. 2 by a his or her finger or by means of a pointer on the touch panel 102 on the LCD 101 displaying an original image 103, a rectangular region 104 whose diagonal corners are the points A and B is set as a specified area 104.

Since this way of specifying an area is merely one example, other ways may be used. For example, if the image processing apparatus 1 has a pointing device, such as a mouse or a touch pad, a specified area can be set by the use of the pointing device and an appropriate marker appearing on the display unit 201.

The miniature image creating unit 30 creates a miniature image by reducing an original image input from the image inputting unit 10.

The miniature image creating unit 30 in this embodiment create a miniature image of an original image so that a specified area and an area lying outside this specified area are reduced by different modes by using specified area data created by the area specifying unit 20.

More specifically, an original image is reduced to a miniature image (thumbnail) with a predetermined size so that the specified area is reduced so as to have higher visibility, a higher image quality, and a more accurate shape than the area outside the specified area.

The miniature image creating unit 30 may be realized by hardware using a logic circuit or by executing a software program by a CPU (computer). Alternatively, the miniature image creating unit 30 may be realized by a combination of hardware and software.

An example of the operation of the image processing apparatus 1 having the structure described above is described below.

The image inputting unit 10 receives the original image 103 from, for example, a hard disk (not shown) contained in the image processing apparatus 1. The original image 103 may be a one page image or an image containing multiple pages.

The original image 103 input from the image inputting unit 10 is displayed on the display unit 201 of the area specifying unit 20, for example, on the LCD 101 on the control panel 100 shown in FIG. 2.

A user presses the points A and B using the area inputting unit 202, for example, the touch panel 102, to set the rectangular region 104 whose diagonal corners are the points A and B as the specified area 104.

If the original image 103 contains multiple pages, the specified area can be set in every page when “all” is selected and can be set in only each specified page when “specific pages” is selected, as shown in FIG. 2.

In the specified-area data creating unit 203, the set specified area 104 is represented as specified area data expressed as, for example, the coordinates in the original image 103.

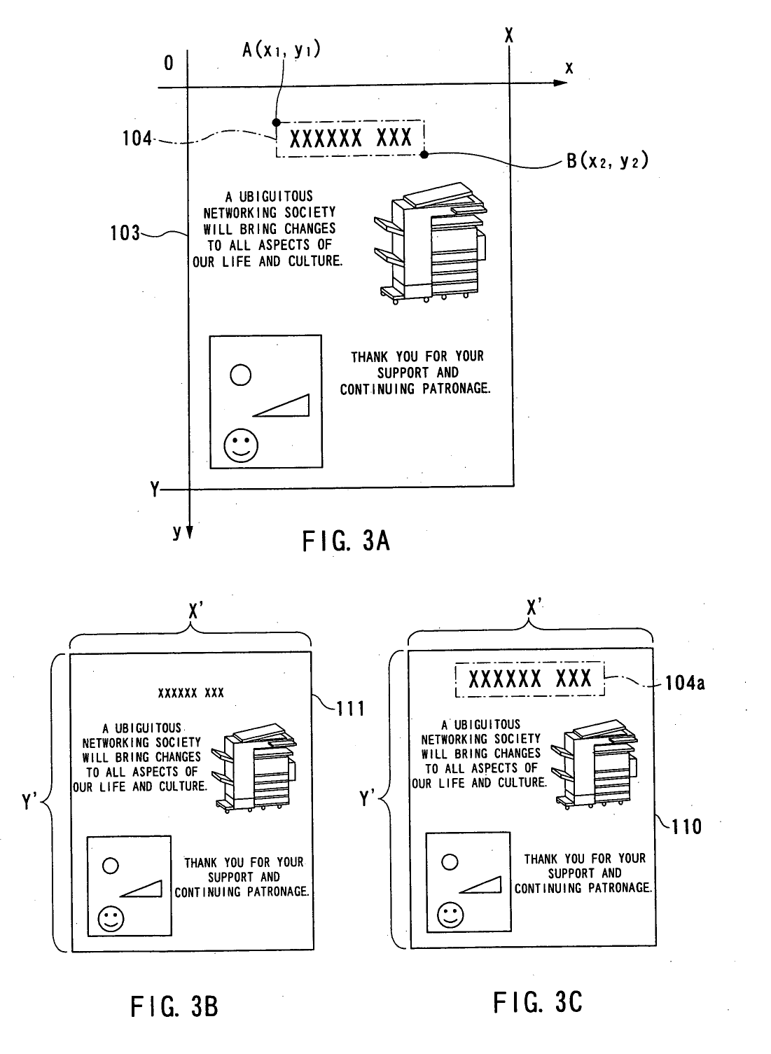

In the miniature image creating unit 30, the original image 103 is reduced to a miniature image (thumbnail) with a predetermined size so that the specified area in the miniature image has higher visibility, a higher image quality, and a more accurate shape than the area outside the specified area 104. An example of the method for reducing the original image is described below with reference to FIGS. 3A to 3C.

FIG. 3A shows the original image 103. The horizontal axis is the x-axis, and the vertical axis is the y-axis in the original image 103. The horizontal length of the original image 103 is represented as X, and the vertical length of the original image 103 is represented as Y. The points A and B serving as two diagonal corners of the specified area 104 are represented as the coordinates (x₁, y₁) and (x₂, y₂), respectively. In this case, it is assumed that x₁<X₂ and y₁<y₂. As a result, the horizontal length of the specified area 104 in the original image 103 is expressed by (x₂−x₁), and the vertical length thereof is expressed by (y₂−y₁).

FIG. 3B shows a miniature image (thumbnail) 111 created by a conventional technique. The horizontal length of the miniature image 111 is represented as “X′”, and the vertical length thereof is represented by “Y′”.

In general, the miniature image 111 is of a fixed size and a fixed aspect ratio (a ratio of the horizontal length to the vertical length) (X′/Y′). In contrast to this, the original image 103 can be of various sizes, and an aspect ratio (X/Y) of the original image 103 varies depending on the type of the original image 103. As a result, typically, the aspect ratio (X/Y) of the original image 103 differs from the aspect ratio (X′/Y′) of the miniature image 111.

For creating the miniature image 111, it is desired that the original image 103 be reduced so as to minimize the gap between the original image 103 and the miniature image 111 in order to ensure the visibility of the original image 103.

Conventionally, in the case where the aspect ratio (X/Y) of the original image 103 differs from the aspect ratio (X′/Y′) of the miniature image 111, a technique for reducing the original image 103 so that the aspect ratio (X/Y) of the original image 103 is equal to the aspect ratio (X′/Y′) of the miniature image 111 is often used. In this case, the aspect ratio of the reduced original image 103 is varied in the miniature image 111.

For such a conventional reduction technique, if the difference between the aspect ratio (X/Y) of the original image 103 and the aspect ratio (X′/Y′) of the miniature image 111 is large, the reduced original image 103 is largely distorted, and as a result, the image has poor visibility. To avoid this, if the original image 103 is reduced such that the aspect ratio (X/Y) of the original image 103 remains unchanged, useless gaps would be present in the miniature image 111.

FIG. 3C shows a miniature image 110 created by the image processing apparatus 1 according to this embodiment. In this embodiment, even when the aspect ratio (X/Y) of the original image 103 differs from an aspect ratio (X′/Y′) of the miniature image 110, the miniature image is created such that the aspect ratio of the specified area 104, which is not reduced, is equal to an aspect ratio of a reduced specified area 104a.

On the other hand, the variations in the aspect ratio of an area outside the specified area 104 are allowable in order to minimize a gap in the miniature image 110.

Additionally, in order to ensure a predetermined area ratio of the specified area 104 in the reduced image, the miniature image is created such that a reduction ratio of the specified area 104 is larger than a reduction ratio of the area other than the specified area 104. As a result, the reduced specified area 104a is displayed more largely than the area outside of the specified area 104.

An example of a reduction method is described below.

(a) If (x₂−x₁)/(y₂−y₁)>X′/Y′ (i.e., the case where the aspect ratio of the specified area 104 is larger than the aspect ratio of the miniature image), the reduction ratio in the x-axis is represented by:

0.8X′/(x₂−x₁) times (for x₁≦x≦x₂)
0.2X′/(X−(x₂−x₁)) times (for x<x₁, x₂<x); and
   the reduction ratio in the y-axis is represented by:
0.8X′/(x₂−x₁) times (for y₁≦y≦y₂)
[Y′−0.8(y₂−y₁)X′/(x₂−x₁)]/(Y−(y₂−y₁) times (for y<y₁, y₂<y)
   (b) If (x₂−x₁)/(y₂−y₁)≦X′/Y′ (i.e., the case where the aspect ratio of the specified area 104 is equal to or smaller than the aspect ratio of the miniature image),
   the reduction ratio in the x-axis is represented by:
0.8Y′/(y₂−y₁) times (for x₁≦x≦x₂)
[X′−0.8(x₂−x₁)Y′/(y₂−y₁)]/(X−(x₂−x₁) times (for x<x₁, x₂<x); and
   the reduction ratio in the y-axis is represented by:
0.8Y′/(y₂−y₁) times (for y₁≦y≦y₂)
0.2Y′/(Y−(y₂−y₁)) times (for y<y₁, y₂<y)

As described above, in the specified area 104 (where x₁≦x≦x₂ and y₁≦y≦y₂), the reduction ratio in the x-axis is the same as that in the y-axis in both case (a) and case (b).

In the above representation, a numerical value of “0.8” indicates a proportion of the reduced specified area 104a to the miniature image 110 (i.e., 80% in this case). As shown in FIG. 3C, when the aspect ratio of the specified area 104 is larger than the aspect ratio of the miniature image 110 (for case (a) described above), the horizontal length of the reduced specified area 104a is 0.8X′, and the horizontal length of the area outside of the reduced specified area 104a is 0.2X′. In other words, as the specified area 104 is reduced to the reduced specified area 104a, the horizontal length is consistently converted to a constant length of 0.8X′. Since the aspect ratio remains unchanged after the reduction of the specified area, the area ratio of the reduced specified area 104a can be set as a numerical value of, for example, “0.8”, and therefore, a large area ratio realizing high visibility can be ensured.

According to the reduction method described above, the aspect ratio of the specified area 104 remains unchanged after the specified area 104 is reduced, even when the aspect ratio of the original image 103 differs from that of the miniature image 110. In addition, the reduced specified area 104a can be displayed so as to be relatively enlarged, even if the area of the specified area 104 is small in the original image 103.

As a result, when the specified area 104 is selected appropriately indicating the content or the feature of the original image 103, a miniature image (thumbnail) appropriately representing the content or the feature of the original image 103 and realizing high visibility and an accurate shape can be created.

The reduction method described above is one exemplary method capable of enhancing the accuracy in reproduction and the visibility by reducing the specified area 104 and the area outside the specified area 104 using different reduction ratios (i.e., different mode) from each other.

Other methods may be used. For example, a method capable of enhancing the accuracy in reproduction and the visibility by reducing the specified area 104 and the area outside the specified area 104 are differently reduced from each other so as to have different resulting image qualities can be employed.

More specifically, the specified area 104 is reduced by a technique for interpolating areas between pixels, such as the bicubic technique or the bilinear technique so as to realize a high image quality. On the other hand, the area outside the specified area 104 is reduced by the nearest neighbor technique, which simply deletes pixels to reduce the size of an image. The image quality realized by the nearest neighbor technique is lower than the bilinear technique and the bicubic technique, but the nearest neighbor technique takes shorter to run through the process than the other two techniques. Therefore, the nearest neighbor technique has the advantage of creating the miniature image (thumbnail) 110 from the original image 103 in a short time.

As described above, since an important area (the specified area 104) and an area other than the important area are reduced by different modes, the miniature image 110 can be created in a short time while ensuring a high image quality of the important area (the specified area 104).

According to the image processing apparatus 1 in the first embodiment, even if an original image includes a complex image section, setting an image section appropriately indicating the content or the feature of the original image as the specified area 104 allows the miniature image (thumbnail) 110 to be readily and quickly created and have high visibility.

### (2) Second Embodiment

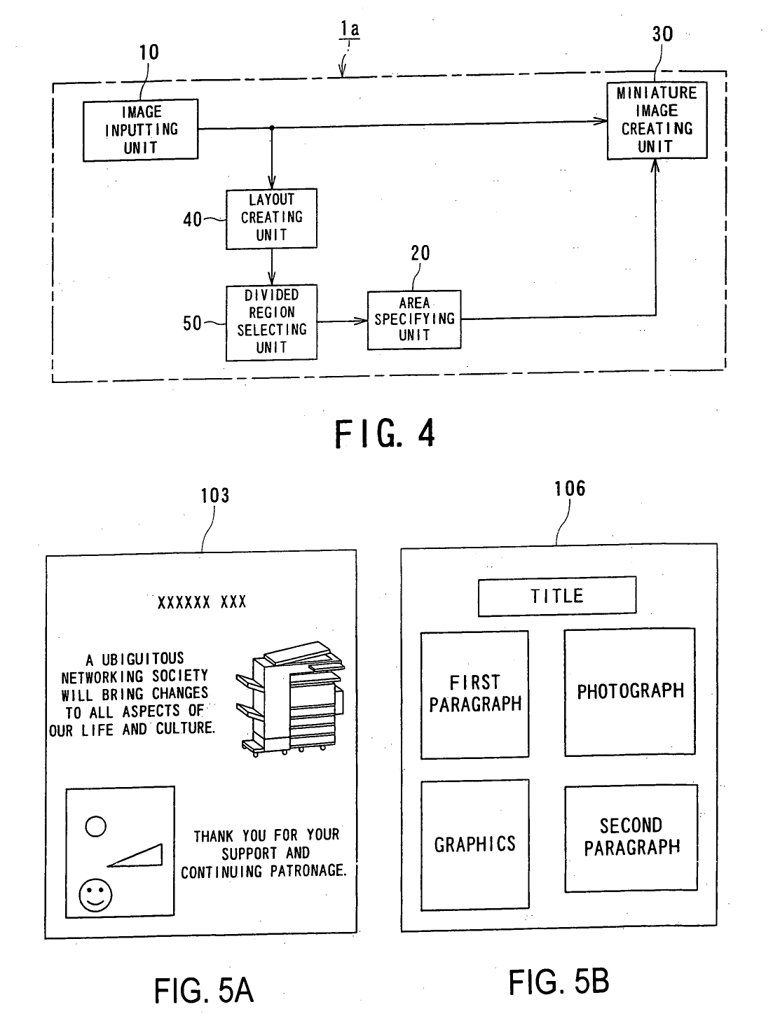

FIG. 4 shows an image processing apparatus 1a according to a second embodiment. The image processing apparatus 1a according to the second embodiment has the structure, in which a layout creating unit 40 and a divided-region selecting unit 50 are added to the image processing apparatus 1 according to the first embodiment.

In general, image data of an original image input from the image inputting unit 10 includes image data sections having one or more attributes. Examples of the attributes include “text”, “title”, “graphics”, “photograph”, “table”, and “graph”.

The layout creating unit 40 analyzes image data of an original image input from the image inputting unit 10, classifies the attributes in accordance with information contained in the image data of the original image and the like, and divides the original image into a plurality of regions individually corresponding to the classified attribute. The arrangement of the divided regions, which are divided individually corresponding to the attributes, can represent a layout of the original image.

Recognizing and classifying the attributes from the original image 103 can be realized by a known technique, for example, the technique disclosed in Japanese Unexamined Patent Application Publication No. 2003-087562.

FIGS. 5A and 5B are illustrations for explanation of a layout 106 (an arrangement of divided regions). FIG. 5A shows the original image 103, and FIG. 5B shows the layout 106 created from the original image 103. In FIGS. 5A and 5B, the original image 103 includes five attributes composed of “title”, “first paragraph”, “photograph”, “graphics”, and “second paragraph”. The layout creating unit 40 analyzes these attributes, divides the original image 103 into the five divided regions individually corresponding to the attributes, and creates the layout 106 by arranging the divided regions.

The divided-region selecting unit 50 selects one or more of the divided regions, which are divided by the layout creating unit 40. The divided regions selected by the divided-region selecting unit 50 are designated as specified areas in the area specifying unit 20 disposed in the next stage. In other words, the divided regions selected by the divided-region selecting unit 50 are identical with the specified areas.

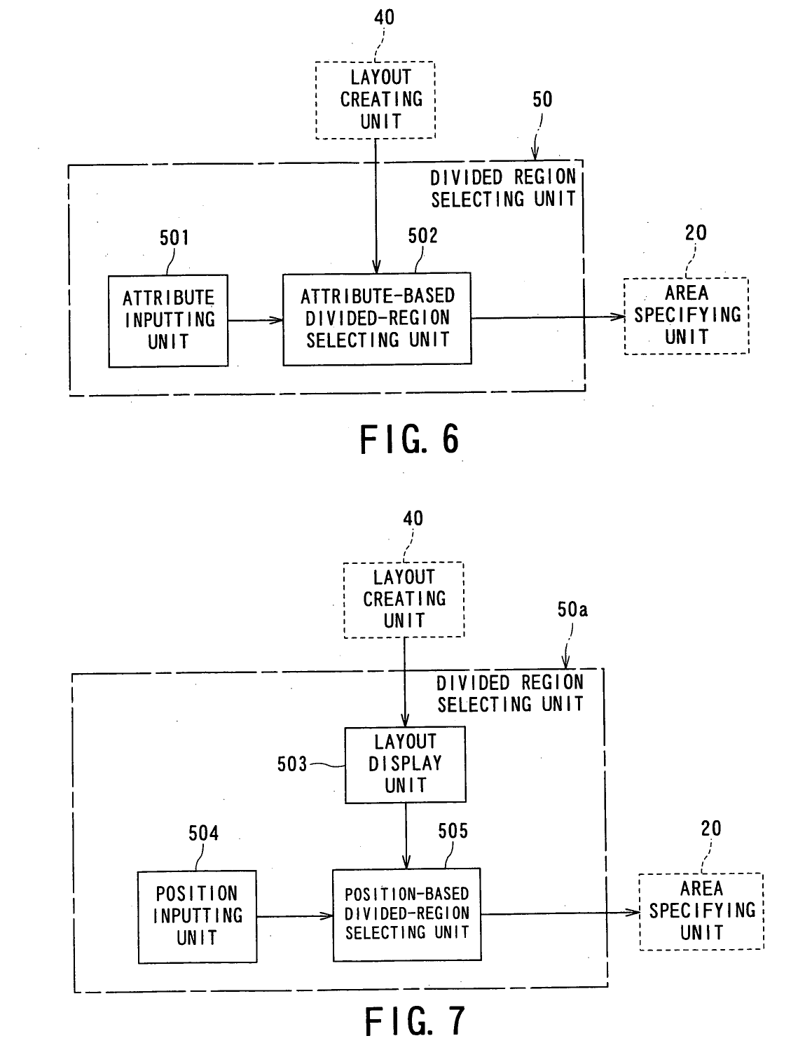

FIG. 6 shows a first example of the divided-region selecting unit 50. In this first example, the divided-region selecting unit 50 includes an attribute inputting unit 501 and an attribute-based divided-region selecting unit 502.

The attribute inputting unit 501 is used for inputting a specific attribute by a user. A user inputs a specific attribute, such as “title”, “graphics”, or “photograph”, in advance using, for example, the operating keys 105 and/or the touch panel 102 disposed on the control panel 100.

The attribute-based divided-region selecting unit 502 selects a divide region corresponding to the input attribute. In the first example, the attribute input by a user determines the specified area.

In the image processing apparatus 1a, the layout creating unit 40 divides the original image into the divided regions individually corresponding to the attributes, and the specified area 104 can be set by simply inputting a desired attribute by a user. Therefore, in addition to the advantageous effects of the first embodiment, the specified area 104 can be set in a simpler manner.

FIG. 7 shows a divided-region selecting unit 50a according to a second example of the divided-region selecting unit 50. In this second example, the divided-region selecting unit 50a includes a layout displaying unit 503, a position inputting unit 504, a position-based divided-region selecting unit 505.

The layout displaying unit 503 is composed of, for example, the LCD 101 disposed on the control panel 100. The position inputting unit 504 is used for specifying or inputting by a user a position of a divided region displayed on the layout displaying unit 503 to select the divided region as the specified area. The position inputting unit 504 may be realized by the operating keys 105 or by the touch panel 102 disposed on the LCD 101. For example, pressing the position of a desired divided region on the touch panel 102 allows the specified area to be readily and quickly set.

In the divided-region selecting unit 50a according to the second example, the specified area 104 can be selected using the touch panel 102 on the displayed layout. Therefore, the specified area 104 can be selected more readily and simply than the divided-region selecting unit 50 according to the first example.

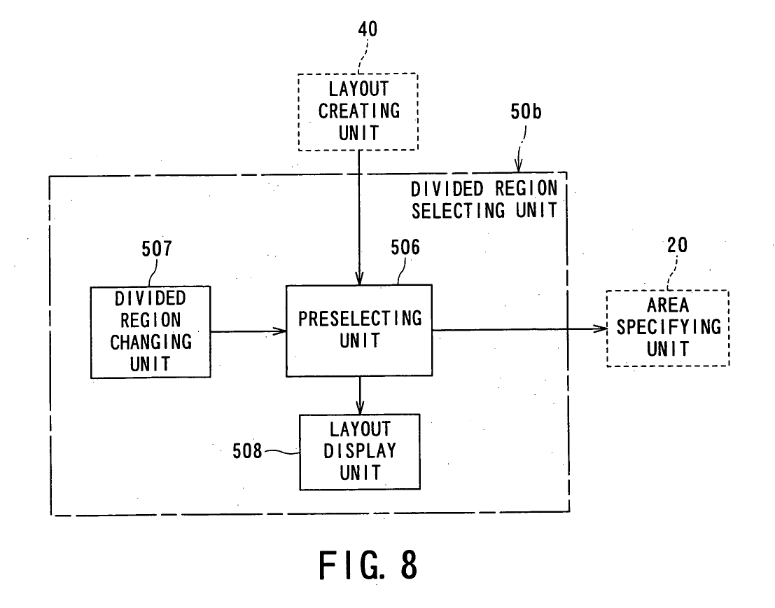

FIG. 8 shows a divided-region selecting unit 50b according to a third example of the divided-region selecting unit 50. In this third example, the divided-region selecting unit 50b includes a preselecting unit 506, a divided-region changing unit 507, a layout displaying unit 508.

The preselecting unit 506 automatically preselects a divided region in a predetermined manner. Examples of the predetermined manner include preferentially selecting a divided region positioned in the top of the original image and, when the original image contains an attribute of “title”, preferentially selecting a divided region whose attribute is “title”.

The selected divided region is displayed on the layout displaying unit 508 so as to be superimposed on the original image or the layout.

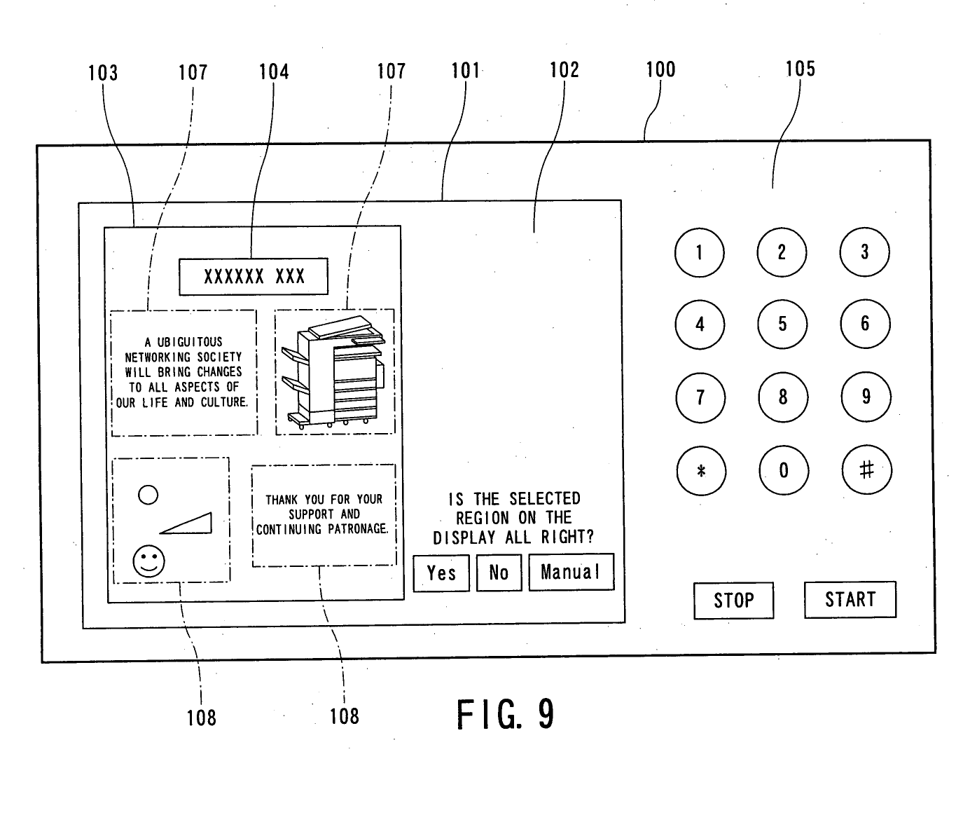

FIG. 9 shows an example of a state in which the divided regions created by the layout creating unit 40 are displayed on the layout displaying unit 508 so as to be superimposed on the original image. The layout displaying unit 508 is realized by, for example, the LCD 101 disposed on the control panel 100. The layout displaying unit 508 (the LCD 101) displays the selected divided region (the specified area 104) surround by solid lines, and the divided regions 107, which are not selected, enclosed by dash-dot lines.

In FIG. 9, the preselecting unit 506 preferentially selects an attribute of “title”. A user can view the currently selected divided region (the specified area 104) using the layout displaying unit 508. To change the specified area 104 from the currently selected divided region to another divide region, pressing a desired divided region on the touch panel 102 (the divided region changing unit 509) disposed on the LCD 101 allows a new specified area 104 to be set.

In the divided-region selecting unit 50b according to the third example, the specified area 104 is automatically preselected, and a user can change the specified area using the touch panel 102 or the like if needed. Therefore, the specified area 104 can be selected more readily and simply.

When the divided region is selected in the divided-region selecting units 50, 50a, and 50b according to the first, second, and third examples, the selected divided region is set as the specified area 104 in the area specifying unit 20.

The miniature image creating unit 30 creates a miniature image such that the specified area 104 is reduced to have higher image quality and a more accurate shape than the other area, as is the case with the first embodiment.

In the image processing apparatus 1a according to the second embodiment, the original image is divided into a plurality of regions individually corresponding to a plurality of attributes. Using information regarding the divided regions allows the entire miniature image to have a smaller file size.

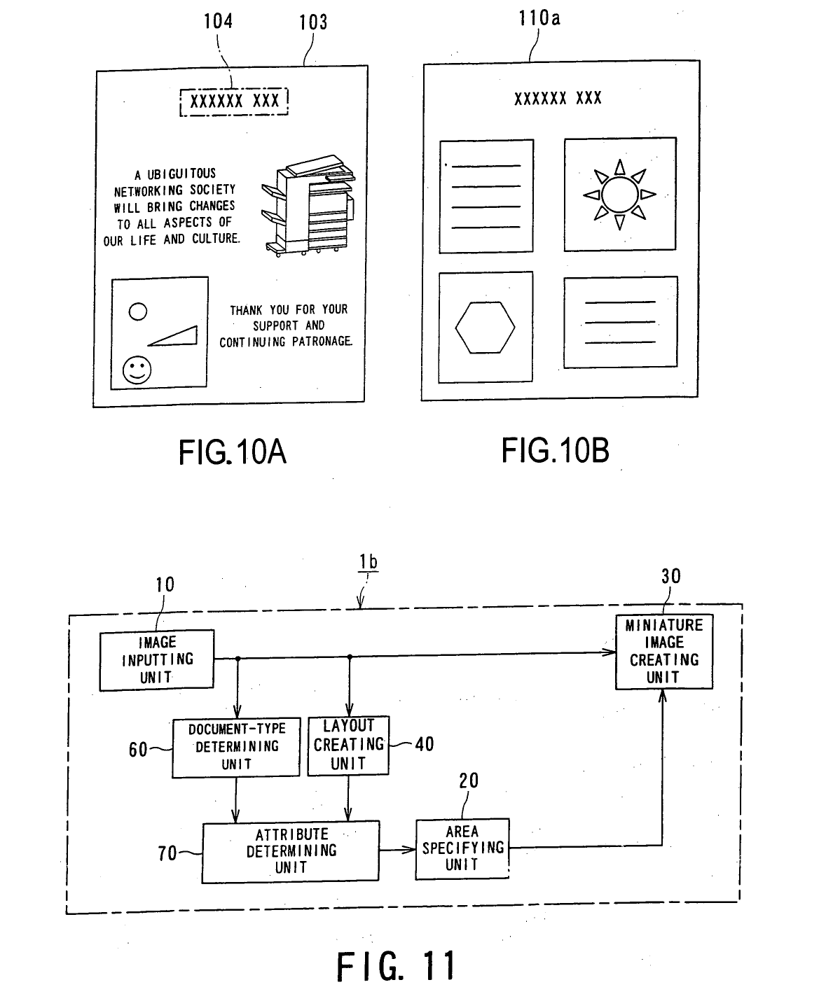

FIGS. 10A and 10B are illustrations for explanation of a miniature image 110a according to another embodiment of the miniature image (thumbnail) created by the image processing apparatus 1a.

The specified area 104 is reduced so as to have a high image quality and an accurate shape by the same technique as the first embodiment.

For an area outside the specified area 104, the recognition of the layout is sufficient in most cases. In such cases, maintaining the content of the original image after the original image is reduced is not necessarily required. Therefore, individually replacing the image sections of divided regions with simpler image sections whose differences are recognizable allows the entire miniature image to have a smaller file size.

For example, as shown in FIGS. 10A and 10B, replacing a text section, a photograph section, a graphics section with simple schematic graphical data with less variations and using an image compression technique, such as joint photographic experts group (JPEG), improves significantly the compression efficiency and makes the file size smaller. Decreasing the file size of the miniature image shortens the time required for reading the miniature image, thus allowing searching and viewing image data to be performed quickly.

When the attribute of the specified area 104 indicates textual information, such as “title”, “table”, or the like, although the resolution is important, gradation and color information are not necessarily important in several cases. In such cases, a structure may be used in which the size of the miniature image section of the specified area 104 is made smaller by decreasing the number of bits for gradations and/or by displaying the miniature image section of the specified area 104 with a gray scale.

When the image file size of the miniature image is sufficiently decreased by replacing the image sections with the simpler image sections, by decreasing the gradations, or the like, the miniature image can be displayed so as to have a large size to some extent, thus increasing visibility and the ease of viewing.

### (3) Third Embodiment

FIG. 11 shows an example of an image processing apparatus 1b according to a third embodiment. The image processing apparatus 1b according to the third embodiment includes the image inputting unit 10, the area specifying unit 20, the miniature image creating unit 30, the layout creating unit 40, a document-type determining unit 60, and an attribute determining unit 70.

The document-type determining unit 60 determines a document type, such as a newspaper, a magazine, a paper, or the like, from input image data of an original image. Determining the document type of the original document may be performed by a known technique, for example, the technique disclosed in Japanese Unexamined Patent Application Publication No. 2004-193674.

The layout creating unit 40 analyzes the attributes of the original image, divides the original image into regions individually corresponding to the attributes, and creates a layout, as is the case with the second embodiment.

The attribute determining unit 70 determines an attribute to be preferentially selected in accordance with the document type. For example, when the document type determined by the document-type determining unit 60 is a technical paper, an attribute of “table” or “graph”, or both is preferentially selected. When the document type is a magazine, an attribute of “title” or “photograph”, or both is preferentially selected. When the document type is a newspaper, an attribute of “date” or “headline”, or both is preferentially selected.

Setting the divided region with the attribute determined by the attribute determining unit 70 as the specified area automatically selects the divided region with an important attribute as the specified area in accordance with the document type. Therefore, setting the specified area becomes simpler. Automatically set specified areas may be changed by a user as needed.

In the image processing apparatus 1b according to the third embodiment, the document type is automatically determined, and a divided area with an attribute that is determined to be important in accordance with the document type is automatically set as the specified area 104. Therefore, the miniature image can be created simply and quickly.

### (4) Fourth Embodiment

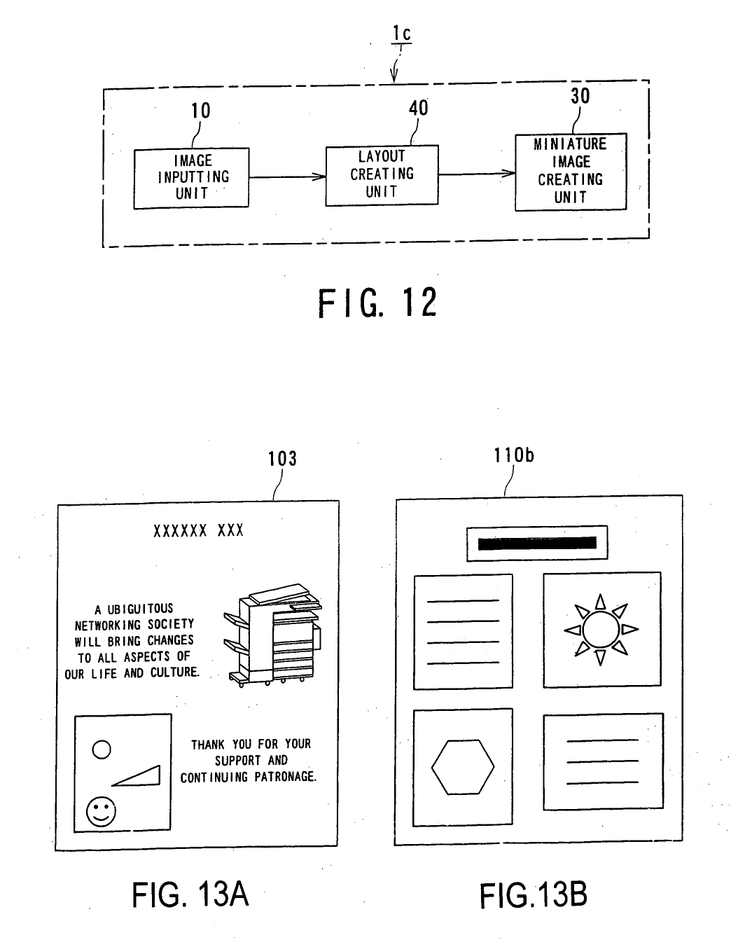

FIG. 12 shows an example of an image processing apparatus 1c according to the fourth embodiment.

The image processing apparatus 1c according to the fourth embodiment includes the image inputting unit 10, the layout creating unit 40, and the miniature image creating unit 30.

In the fourth embodiment, as shown in FIGS. 13A and 13B, only layout information is extracted from the original image 103, and a miniature image 110b indicating only a layout is crated.

Extracting the layout is realized by the layout creating unit 40 performing the same processing as the second embodiment.

When only the layout is displayed, specific image information about the original image is not necessarily required. Accordingly, the miniature image is created such that image information is replaced with simple image data, as shown in FIG. 13B. As a result, the size of image file can be decreased.

In the image processing apparatus 1c according to the fourth embodiment, if the original image can be viewed and searched using the layout, the miniature image indicating only the layout is automatically created from the original image. Since the miniature image is created such that the image sections are replaced with simpler image data, the size of the image file is decreased, thus realizing viewing image data at high speed.

While the present invention has been described with reference to exemplary embodiments, it is to be understood that the invention is not limited to the disclosed embodiments. The invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image processing apparatus comprising:
an image inputting unit configured to input image data of an original image;
an area specifying unit configured to specify a predetermined area in the input original image as a specified area; and
a miniature image creating unit configured to create a miniature image of the original image such that a first image section of the specified area and a second image section of an area other than the specified area specified by the image inputting unit are reduced by different modes from each other.

2. The image processing apparatus according to claim 1, wherein the miniature image creating unit creates the miniature image such that an aspect ratio of the specified area in the original image is equal to an aspect ratio of the specified area in the miniature image even when an aspect ratio of the original image differs from an aspect ratio of the miniature image.

3. The image processing apparatus according to claim 2, wherein the miniature image creating unit creates the miniature image such that a reduction ratio of the specified area in the miniature image is larger than a reduction ratio of the area other than the specified area in the miniature image.

4. The image processing apparatus according to claim 1, wherein the miniature image creating unit creates the miniature image by a reduction method in which the reduced first image section of the specified area has less degradation in image quality than the reduced second image section of the area other than the specified area.

5. The image processing apparatus according to claim 1, wherein the area specifying unit comprises:
a display unit configured to display the original image; and
an area inputting unit configured to input a predetermined area of the displayed original image.

6. The image processing apparatus according to claim 5, wherein the area inputting unit includes a touch panel.

7. The image processing apparatus according to claim 1, further comprising:
a layout creating unit configured to analyze a plurality of attributes contained in the original image, to divide the original image into a plurality of regions individually corresponding to the attributes, and to create a layout of the original image by arranging the plurality of divided regions; and
a divided-region selecting unit configured to select at least one divided region from the plurality of divided regions,
wherein the area specifying unit designates the selected divided region as the specified area.

8. The image processing apparatus according to claim 7, wherein the divided-region selecting unit comprises an attribute inputting unit configured to input at least one of the plurality of attributes, and
the divided-region selecting unit selects the divided region corresponding to the input attribute.

9. The image processing apparatus according to claim 7, wherein the divided-region selecting unit comprises:
a layout displaying unit configured to display the created layout; and
a position inputting unit configured to input a position of the divided region,
wherein the divided-region selecting unit selects the divided region by specifying the position of the divided region in the displayed layout.

10. The image processing apparatus according to claim 7, wherein the divided-region selecting unit comprises:
a preselecting unit configured to preselect a predetermined divided region from the plurality of divided regions;
a layout displaying unit configured to display the created layout and to display the preselected divided region so as to be superimposed on the displayed layout and be readily recognizable; and
a region changing unit configured to be capable of changing the selection from the preselected divided region to another divided region,
wherein the divided-region selecting unit selects the preselected divided region or another divided region to which the selection is changed.

11. The image processing apparatus according to claim 1, further comprising:
a layout creating unit configured to analyze a plurality of attributes contained in the original image, to divide the original image into a plurality of regions individually corresponding to the attributes, and to create a layout of the original image by arranging the plurality of divided regions; and
a divided-region selecting unit configured to select at least one divided region from the plurality of divided regions,
wherein the area specifying unit designates the selected divided region as the specified area, and
the miniature image creating unit creates the miniature image such that an image section of an unselected divided region other than the selected divided region is replaced with a predetermined simple image section.

12. The image processing apparatus according to claim 1, further comprising:
a document type determining unit configured to determine a document type of the original image;
a layout creating unit configured to analyze a plurality of attributes of the original image, to divide the original image into a plurality of regions individually corresponding to the attributes, and to create a layout of the original image by arranging the plurality of divided regions; and
an attribute determining unit configured to determine an attribute to be preferentially selected from the plurality of attributes contained in the original image in accordance with the determined document type,
wherein the area specifying unit designates the divided region corresponding to the determined attribute as the specified area.

13. An image processing apparatus comprising:
an image inputting unit configured to input image data of an original image;
a layout creating unit configured to analyze a plurality of attributes contained in the original image, to divide the original image into a plurality of regions individually corresponding to the attributes, and to create a layout of the original image by arranging the plurality of divided regions; and
a miniature image creating unit configured to create a miniature image of the original image after an image section of at least one of the divided regions is replaced with a predetermined simple image section.

14. An image processing method comprising:
an image inputting step of inputting image data of an original image;
an area specifying step of specifying a predetermined area in the input original image as a specified area; and
a miniature image creating step of creating a miniature image of the original image such that a first image section of the specified area and a second image section of an area other than the specified area are reduced by different modes from each other.

15. The image processing method according to claim 14, wherein the miniature image creating step creates the miniature image such that an aspect ratio of the specified area in the original image is equal to an aspect ratio of the specified area in the miniature image even when an aspect ratio of the original image differs from an aspect ratio of the miniature image.

16. The image processing method according to claim 14, wherein the miniature image creating step creates the miniature image such that a reduction ratio of the specified area in the miniature image is larger than a reduction ratio of the area other than the specified area in the miniature image.

17. The image processing method according to claim 14, wherein the miniature image creating step creates the miniature image by a reduction method in which the reduced first image section of the specified area has less degradation in image quality than the reduced second image section of the area other than the specified area.

18. The image processing method according to claim 14, further comprising:
a layout creating step of analyzing a plurality of attributes contained in the original image, of dividing the original image into a plurality of regions individually corresponding to the attributes, and of creating a layout of the original image by arranging the plurality of divided regions; and
a divided-region selecting step of selecting at least one divided region from the plurality of divided regions,
wherein the area specifying step designates the selected divided region as the specified area.

19. The image processing method according to claim 14, further comprising:
a document type determining step of determining a document type of the original image;
a layout creating step of analyzing a plurality of attributes of the original image, of dividing the original image into a plurality of regions individually corresponding to the attributes, and of creating a layout of the original image by arranging the plurality of divided regions; and
an attribute determining step of determining an attribute to be preferentially selected from the plurality of attributes contained in the original image in accordance with the determined document type,
wherein the area specifying step designates the divided region corresponding to the determined attribute as the specified area.
